(19) United States
(12) Patent Application Publication
(10) Pub. No.: US 2010/0196576 A1
(43) Pub. Date: Aug. 5, 2010

(54) Fruit Product and Method of Manufacture of the Fruit Product

(75) Inventors: William V. Traina, Patterson, CA (US); Paul W. Walker, Stockton, CA (US); Charles C. Huxsoll, Moraga, CA (US); Francis R. Fiorini, Turlock, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Traina-Fiorini, LLC, Patterson, CA (US)

(21) Appl. No.: 12/756,136

(22) Filed: Apr. 7, 2010

Related U.S. Application Data
(62) Division of application No. 11/734,733, filed on Apr. 12, 2007.
(60) Provisional application No. 60/792,928, filed on Apr. 17, 2006.

(51) Int. Cl. A23L 1/06

(52) U.S. Cl. 426/578

(57) ABSTRACT

A fruit product that is a fruit-gel matrix that is formed into pieces. The product is a shelf-stable item that contains preferably at least 85%, and more preferably about 95%, fruit solids. The product is intended to be a nutritious snack or meal accompaniment. While containing a high percentage of fruit, the product has eating qualities associated with jelly gum confections.

### CROSS-REFERENCES TO RELATED APPLICATIONS

This application claims priority to U.S. Provisional Patent Application No. 60/792,928, filed Apr. 17, 2006 whose teachings are incorporated herein by reference.

### BACKGROUND OF THE INVENTION

The present invention relates to a fruit product and a method for its manufacture.

Restructured fruit snacks currently on the market usually contain 100% fruit solids, and are made by simply combining various forms of dehydrated fruits with concentrated fruit syrups and purees. These components are mixed, or blended, and formed into shapes, typically bars. While these products have the desirable characteristic of being “all fruit,” they frequently lack appealing texture. The texture is often described as “grainy” or “tough.”

Jelly gum candies are typically made by combining liquid corn sugar, gel-forming starch, dry sugar, flavorings and colorants. Additional gelling components, such as gelatin, pectin, or gums are often added. After gelatinizing the starch, the mixtures are deposited into molds, usually starch molds, to form the piece. The deposited material can contain about 75-80% solids, and it must be further dried in the mold to have about 82-85% solids. Drying may take from as little as several hours to 48 hours, but a drying period of about at least 24 hours is common.

Gelatinizing the starch is a key step in the jelly gum process. In dilute solutions most starches can be gelatinized at the boiling temperature of water at atmospheric pressure. But dilute solutions are undesirable because, in order to reach the 75% solids level, most of the water must be removed by boiling down the solution. In the past, this was done in the “open kettle” processes.

In order to gelatinize starch in high concentration sugar solutions, temperatures need to be raised to a range of about 285-335° F. To do this, most large candy processors use direct steam injection systems, which cook the starch/sugar solutions by directing steam into the flowing solution at a pressure that will attain the necessary temperature. Using this technique avoids the need to use dilute solutions, and the mixtures may be directly deposited into the molds.

An alternate process utilizes pre-gelatinized starch and eliminates the need to use the high temperatures required to gelatinize starch in high concentration sugar solutions. The decision to use un-gelatinized or pre-gelatinized starch depends in part on the kind of final gel properties that may be desired.

While jelly gum candies have a texture that may not be grainy or tough, such candies are far from being “all fruit.” There is therefore a need for a mostly fruit snack product that does not suffer from the above shortcomings.

### BRIEF SUMMARY OF THE INVENTION

The present invention provides a fruit product that is a fruit-gel matrix that is formed into pieces. The product is a shelf-stable item that contains at least 85%, and up to about 95%, fruit solids. The product is intended to be a nutritious snack or a meal accompaniment. While containing a high percentage of fruit, the product has eating qualities associated with jelly gum confections.

In accordance with the embodiments of the present invention, a fruit product is made by processes that could resemble the jelly gum processes, which has been enhanced with several novel modifications. For one, concentrated fruit syrup replaces corn syrup, and fruit powders replace the sugar. Furthermore, instead of using a molding process to shape the pieces, a forming process can make the pieces directly into the desired shapes. A forming device, such as a Vemag vacuum sausage stuffer, or other equivalent forming device can be used for making the pieces.

In one aspect, the present invention provides a method for manufacturing a fruit product having a fruit-gel matrix. The method includes: heating concentrated sugar syrup at about 70% solids to about 190° F.; adding starch and blending it into the syrup; heating the starch portion to near its boiling point, about 220° F.; injecting culinary quality steam at about 60-100 psig into the starch solution to raise its temperature to range between about 285° F. to about 335° F., whereby the starch gelatinizes; adding flavoring and colorants to the starch solution; incorporating the requisite amount of fruit powder into the starch solution and mixing until the solution is uniform; maintaining heating of the solution to prevent the solution from setting during mixing; and forming pieces of the fruit product from the solution.

In another aspect, the present invention provides a method for manufacturing a fruit product comprising a fruit-gel matrix. The method includes: blending a fruit powder and a pre-gelatinized starch; heating a fruit concentrate to about its boiling point; adding a concentrated pectin solution to the fruit concentrate to provide requisite amount of pectin; adding flavorings and colorants to the fruit concentrate; mixing the concentrated solution; adding the fruit powder and the pre-gelatinized starch blend to the concentrate solution; mixing the concentrate solution, the fruit powder and the pre-gelatinized starch blend until the fruit powder and the pre-gelatinized starch are hydrated; transferring the mixture to a forming device; and forming the mixture into desired pieces using the forming device.

For a further understanding of the nature and advantages of the invention, reference should be made to the following description. It is to be expressly understood, however, that each of the examples is provided for the purpose of illustration and description only and is not intended as a definition of the limits of the embodiments of the present invention.

### DETAILED DESCRIPTION OF THE INVENTION

The embodiments of the present invention provide a process for making a fruit product using ungelatinized or pre-gelatinized starch. A preferred embodiment for the process is as follows: concentrated sugar syrup at about 70% solids is heated, in a steam-jacketed kettle for example, to about 190° F. Starch is added and blended into the syrup with a high-speed mixer until well-mixed. Pectin, when used, is mixed into a separate portion of syrup, diluted to about 20 to 30% solids and heated to about 190° F. A high speed mixing device, with a strong shearing action, such as a shear pump or shear mill, may be used to disperse and dissolve the pectin. A high concentration pectin solution is made in the diluted syrup and maintained at a temperature above its setting point about 160° F., but below a temperature where the pectin may start to de-polymerize. The starch portion is heated to near its boiling point, about 220° F. and passed through a direct steam injection (DSI) heater. Culinary quality steam at about 60-prig is injected into the starch solution to raise its temperature to about 290° F., where the starch gelatinizes. When the solution exits the DSI heater it returns to atmospheric pressure, whereby steam is released, and the temperature returns to the atmospheric boiling temperature of the mixture. The gelatinized starch solution and the requisite amount of the concentrated dispersed pectin solution are added to a mixer and blended. Flavoring and colorants are added to the mixer, and then the requisite amount of fruit powder is incorporated and mixed until the mixture is uniform. The mixer is heated, with a steam jacket for example, to prevent the material from setting prior to forming into pieces. The material leaving the mixer is at a temperature where it may be readily formed into shapes, but sufficiently firm so that the formed pieces will maintain physical integrity, generally about 120° F. After forming, the pieces may be chilled to enhance the setting of the gel.

In another embodiment, pre-gelatinized starch is used. The process for making the product using pre-gelatinized starch is similar to the one for using ungelatinized starch, but there is no need to heat any of the solution to the high gelatinizing temperature. Pectin, when used, is mixed into a separate portion of syrup, diluted to about 20 to 30% solids and heated to about 190° F. A high speed mixing device, with a strong shearing action, such as a shear pump or shear mill, may be used to disperse and dissolve the pectin. A high concentration pectin solution is made in the diluted syrup and maintained at a temperature above its setting point about 160° F., but below a temperature where the pectin may start to de-polymerize. The fruit concentrate is heated to above the setting temperature of the pectin, and the requisite amount of the concentrated pectin solution is added. The solution is placed in the mixer, and the pre-gelatinized starch, flavorings and colorants are added. When these ingredients are thoroughly mixed, the fruit powder is incorporated and mixed until the mixture is uniform. The mixture is placed in a forming device to make the pieces. Alternatively, the starch may be pre-blended with the fruit powder, and both ingredients may be added to the mixer simultaneously.

A preferred formulation for the fruit-gel matrix contains fruit syrup, fruit powder, gelling starch, pectin, flavorings, and colorants. Those skilled in the art will understand that various ingredients may be used as desired or as not desired. For example, pectin may be omitted if desired.

In order for the product to be shelf stable, its water activity can be about 0.60 or less. The water activity is largely determined by the ratio of fruit syrup to fruit powder. The combined syrup and fruit powder have a solids content of about 80%. Fruit syrup concentrates are nominally 70% solids, and fruit powders range from about 95% to 99% solids. Assuming syrup at 70% solids and fruit powder at 97% solids, the ratio of syrup to powder would be 60 parts syrup to 37 parts powder for an 80% solids mixture. On a dry solids basis the matrix contains preferably 85% fruit solids, and more preferably, 95% or higher fruit solids. The ratios of fruit concentrate solids to fruit powder solids can vary from about 60% concentrate solids to 40% powder solids to about 40% concentrate solids to 60% powder solids. The ratio of concentrate solids to powder solids may be varied to change the consistency of the mixture.

The gelling starch and pectin levels can also affect the texture. Depending upon the texture desired the starch may range from about 1% to 10% by weight of the mixture, and pectin may range from none to 4% by weight of the mixture. Flavoring and coloring levels each can range from about 0.1% to 1%.

An example of a formulation for the fruit product is as follows:

| | |
|---|---|
| Concentrated Fruit Syrup | 58.6% |
| Fruit Powder | 34.4% |
| Starch | 4.0% |
| Pectin | 1.0% |
| Flavoring | 1.0% |
| Colorants | 1.0% |

Another example of a formulation for the fruit product is as follows:

| | |
|---|---|
| Concentrated Fruit Syrup | 51% |
| Fruit Powder | 44% |
| Starch | 2.5% |
| Pectin | 0.9% |
| Flavoring | 0.8% |
| Colorant | 0.8% |

In addition, the following variations to the above alternative formulation illustrate the addition of nutraceutical, nutritional, textural and flavor quality enhancer to the above formulation. These variations are as follows:

Variation 1: This variation includes the addition of about 0.5% ascorbic acid to the above exemplary formulation.

Variation 2: This variation includes the addition of about 5% whey protein isolate to the above exemplary formulation.

Variation 3: This variation includes the addition of about 5% walnut meal to the above exemplary formulation.

Variation 4: This variation includes the addition of about 10% fruit bit medley to the above exemplary formulation.

The concentrated fruit syrup may be from many fruit sources, such as apple, pear, pineapple, and grape. The choice of syrup will be largely determined by cost, flavor, and solids level.

The fruit powder may also be from a variety of fruit sources. The choice of powder will be determined by flavor and color. For example, drum-dried fruit flake powders may be used for this product.

Flavorings can be from natural sources, and typically contain a primary flavor “with other natural flavors (WONF),” such as peach WONF, strawberry WONF, and the like. If desired, organic acids may also be used to provide the desired flavor profile.

Colorings can also be from natural sources, particularly fruit and vegetable sources and can match the flavor, such as red for strawberry and orange for peach, and so on.

Nutritional fortifiers, such as protein supplements, vitamins, and other nutriceuticals may be added to the fruit-gel matrix, usually in the final mixing process. Nutmeats, dried fruit bits, puffed cereals, and similar ingredients may be added to the matrix prior to forming to add flavor and textural qualities as desired.

For the method of manufacture, in summary a mixture of fruit juice concentrate and gelling starch is made. The starch may be ungelatinized or pre-gelatinized. If ungelatinized starch is used, the mixture is heated to a temperature that causes the starch to gelatinize. The starch is gelatinized in order for the mixture to form a gel structure upon cooling. Gelatinization is most efficiently accomplished with a direct steam injection system. When pre-gelatinized starch is used the starch may be mixed with the juice concentrate, and no heating is necessary. If an additional gel-forming ingredient is used, such as pectin, it may be necessary to make an additional mixture of juice concentrate and pectin, for example. The concentrated fruit syrup/starch/pectin mixtures are blended in a mixing device. Flavorings, colorants, and nutritional fortifiers can also be added in the mixer. Dried fruit powders are added to the mix in quantity sufficient to bring the water activity of the material to 0.60 or less. Nutmeats, dried fruit bits, cereal products and other ingredients to provide desired flavor and texture qualities may also be added in the mixer. The mixer should preferably be capable of maintaining the temperature of the mixture high enough to prevent the material from gelling excessively prior to the forming process. Following thorough mixing, the material is formed into pieces. The pieces may be a wide variety of shapes and sizes, such as bars, cylinders, rings, stars, or any shape that can be made with a proper die. A Vemag vacuum sausage stuffer is an example of a suitable forming machine.

A primary advantage of this product and process are that it yields a nutritious food with high fruit content and it is made without need for expensive starch molding and final drying. The product may be consumed as a snack or as an adjunct to a meal.

As will be understood by those skilled in the art, other equivalent or alternative ingredients and methods for forming the novel fruit product in accordance with the embodiments of the present invention can be envisioned without departing from the essential characteristics thereof. Accordingly, the foregoing disclosure is intended to be illustrative of, but not limiting to, the scope of the invention that is set forth in the following claims.

1-20. (canceled)

21. A method for manufacturing a fruit product comprising a fruit-gel matrix, the method comprising:
blending a fruit powder and a pre-gelatinized starch;
heating a fruit concentrate to about its boiling point;
adding a concentrated pectin solution to the fruit concentrate to provide requisite amount of pectin;
adding flavorings and colorants to the fruit concentrate;
mixing the concentrated solution;
adding the fruit powder and the pre-gelatinized starch blend to the concentrate solution;
mixing the concentrate solution, the fruit powder and the pre-gelatinized starch blend until the fruit powder and the pre-gelatinized starch are hydrated;
transferring the mixture to a forming device; and
forming the mixture into desired pieces using the forming device.

22. The method of claim 21 further comprising chilling the pieces after said forming.

23. The method of claim 21 wherein said forming is performed in the absence of a starch mold.

24. The method of claim 21 wherein the fruit product contains at least 85% fruit solids.

25. The method of claim 21 wherein the fruit product contains at least 95% fruit solids.

26. The method of claim 21 wherein the fruit concentrate is a fruit syrup obtained from fruit sources selected from the group consisting of: apples, pears, pineapples, grape, and combinations thereof.

27. The method of claim 21 wherein the fruit powder is a drum-dried fruit flake powder.

28. The method of claim 21 wherein the flavorings are from natural sources, and which contain a primary flavor with other natural flavors (WONF).

29. The method of claim 28 wherein the flavorings are selected from a group consisting of peach WONF, strawberry WONF, and combinations thereof.

30. The method of claim 21 further comprising adding an organic acid.
